(19) United States
(12) Patent Application Publication
(10) Pub. No.: US 2013/0069290 A1
(43) Pub. Date: Mar. 21, 2013

(54) SPRING DEVICE FOR DOOR HANDLE

(71) Applicant: TE-YU CHEN, Pingtung City (TW)

(72) Inventor: TE-YU CHEN, Pingtung City (TW)

(21) Appl. No.: 13/233,046

(22) Filed: Sep. 15, 2011

(51) Int. Cl. F16F 3/00; E05B 1/00

(52) U.S. Cl. 267/150

(57) ABSTRACT

The spring device contains an upper plate, a lower plate, and a base sandwiched between the upper and lower plates. The base has a major opening and a side opening for accommodating a first elastic element and a second elastic element, respectively. The first elastic element has its two ends fixed to two positioning posts on the lower plate. A rotational seat also positioned in the major opening of the base has an arm fixed to a central part of the first elastic element. The upper and lower plates are then riveted together to house the other components inside to form the spring device. After the spring device is configured with a door handle, the door handle can be turned clockwise or counterclockwise to open/close a door and the door handle is then automatically restored to its original position after turning.

### (a) TECHNICAL FIELD OF THE INVENTION

The present invention is generally related to door handles, and more particular to a spring device for a door handle so that the door handle can be turned clockwise or counter-clockwise to open/close a door and the door handle is automatically restored to its original position after turning.

### (b) DESCRIPTION OF THE PRIOR ART

Conventionally, in order to restore a door handle back to its original position after being turned to open or close a door, a spring mechanism is installed inside the door handle. For each type of door handle, usually the spring mechanism has to be designed specifically for the door handle and cannot be applied to other types of door handles, effectively reducing the applicability of the spring mechanism. Additionally, conventional door handles can only be turned clockwise but not the other way around. This would be quite inconvenient when turning the door handle with both hands full.

### SUMMARY OF THE INVENTION

Therefore, a major objective of the present invention is to provide a spring device for configuring with a door handle so that the door handle can be turned clockwise or counterclockwise to open/close a door and the door handle is then automatically restored to its original position after turning.

The spring device contains an upper plate, a lower plate, and a base sandwiched between the upper and lower plates. The base has a major opening and a side opening for accommodating a first elastic element and a second elastic element, respectively. The first elastic element has its two ends fixed to two positioning posts on the lower plate. A rotational seat also positioned in the major opening of the base has an arm fixed to a central part of the first elastic element. The upper and lower plates are then riveted together to house the other components inside to form the spring device.

The upper and lower plates have corresponding and aligned locking holes for riveting by pins.

The rotational seat has a rib on a side opposite to the arm and the rib has a notch for the embedding of a protrusion on the second elastic element so that the rotational seat is accurately positioned when it is restored to its original position after turning.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective break-down diagram showing the various components of a spring device according to an embodiment of the present invention.

FIG. 2 is a sectional diagram showing the spring device of FIG. 1 after its assembly.

FIG. 3 is a perspective diagram showing the spring device of FIG. 1 configured with a door handle.

FIG. 4 is a sectional diagram showing the spring device of FIG. 1 when it is turned clockwise.

FIG. 5 is a sectional diagram showing the spring device of FIG. 1 when it is turned counterclockwise.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

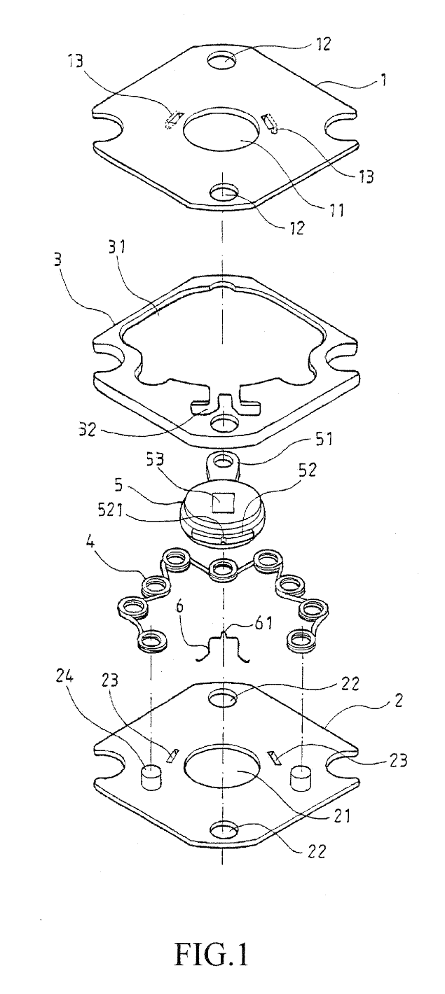

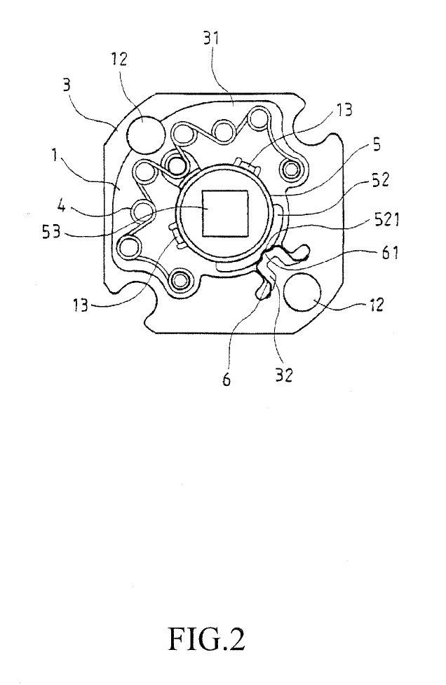

FIGS. 1 and 2 show a spring device according to an embodiment of the present invention before and after it is assembled. As illustrated, the spring device contains an upper plate 1, a lower plate 2, a base 3 sandwiched between the upper and lower plates 1 and 2, and a first elastic element 4, a rotational seat 5, and a second elastic element 6, all embedded in the base 3. The upper plate 1 has a central hole 11, two locking holes 12 at two sides of the central hole 11, respectively, and two blocking pieces 13 (each formed by stamping a C-shaped notch out of the upper plate 1 and then bending the dangling piece perpendicularly).

The lower plate 2 has a central hole 21, two locking holes 22, and two slots 23 corresponding to and aligned with the central hole 11, the locking holes 12, and the blocking pieces 13 of the upper plate 1. The lower plate 2 also has a pair of opposing and cylindrical positioning posts 24.

The base 3 has a major opening 31 for the accommodation of the first elastic element 4. A p-shaped side opening 32 is connected to a side of the major opening 31 for the accommodation of the second elastic element 6.

The first elastic element 4 contains a number of helical torsion springs series-connected into a planar arc shape. When it is twisted to one lateral side, the first elastic element 4 will return to its original shape after release. The two ends of the first elastic element 4 are threaded by the two positioning posts 24.

The rotational seat 5 contains an axial through channel 53, an arm 51 extended from a side, and a rib 52 protruding from an opposing side. The rib 52 has inwardly indented notch 521

The second elastic element 6 is p-shaped and has a protrusion 61 from the straight segment of the p shape.

To assemble the spring device, the center of the first elastic element 4 is fixedly joined to the arm 51 of the rotational seat 5. Then, the upper plate 1, the base 3, and the lower plate 2 are stacked so that the top and bottom sides of the rotational seat 5 are exposed out of the central holes 11 and 21 of the upper and lower plates 1 and 2, respectively. In the meantime, the blocking pieces 13 of the upper plate 1 are received by the slots 23 of the lower plate 2. Finally, the spring device is assembled after the positioning holes 12 and 22 are riveted together by pins.

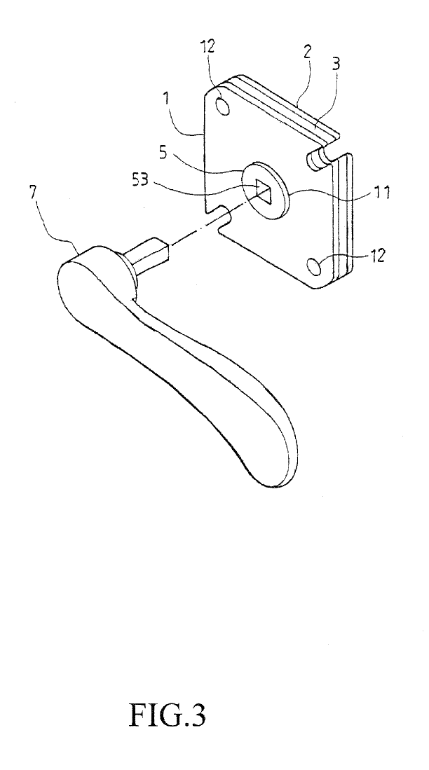

FIG. 3 is a perspective diagram showing the spring device is configured with a door handle 7. As illustrated, the top and bottom sides of the rotational seat 5 are exposed out of the central holes 11 and 21 of the upper and lower plates 1 and 2. Then, after the spring device is installed in a door (not shown), the axis of the door handle 7 is threaded into the through channel 53 of the rotational seat 5.

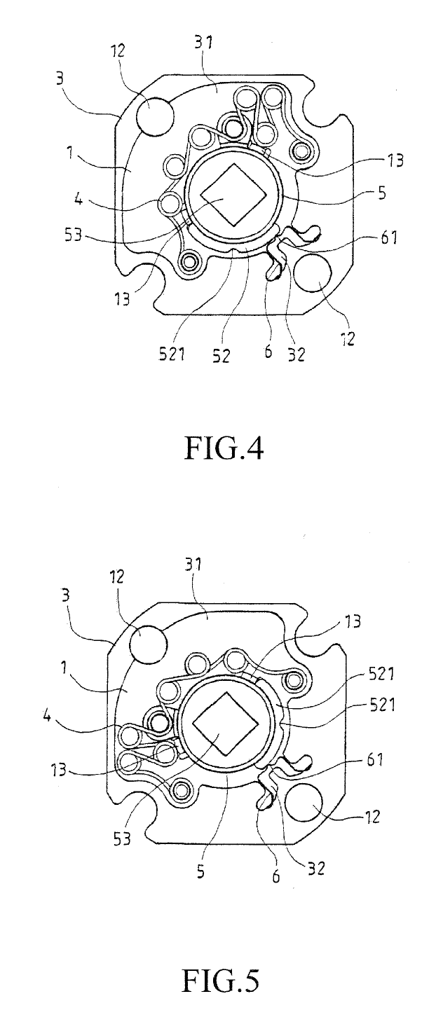

As also shown in FIGS. 4 and 5, when the door handle 7 is turned clockwise or counterclockwise, a part of the first elastic element 4 is compressed while the other part is stretched as the first elastic element 4 is twisted to a side due to the arm 51's fixation to the center of the first elastic element 4. When the rotational seat 5 is turned up to a specific degree, the rib 51 opposite to the aim 51 is blocked by one of the blocking pieces 13 so as to prevent the rotational seat 5 from too much turning and as such damage. When the door handle 7 is released, the resilience of the first elastic element 4 restores the rotational seat 5 to its original position. In the meantime, the protrusion 61 of the second elastic element 6 is embedded into the notch 521 of the rotational seat 5 so as to prevent the door handle 7 from dangling.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A spring device for a door handle, comprising:
an upper plate having an upper central hole and two blocking pieces at two sides of said upper central hole;
a lower plate having a lower central hole and two slots corresponding to and aligned with said upper central hole and said blocking pieces, respectively;
a planar arc-shaped first elastic element resilient against twisting clockwise and counterclockwise, said first elastic element having its two ends fixed to said two positioning posts, respectively;
a π-shaped second elastic element having a protrusion from a straight segment of said π shape; and
a base sandwiched between said upper and lower plates, said base having a major opening and a side opening connected to said major opening for accommodating said first and second elastic elements, respectively; and
a rotational seat having an axial through channel for receiving an axis of said door handle, an arm extended from a side, and a rib protruding from the other side, said rib having a inwardly indented notch;
wherein said arm of said rotational seat fixedly joined to the center of said first elastic element; the top and bottom sides of said rotational seat are exposed out of said first and second central holes, respectively; and said blocking pieces are received by said slots, respectively.

2. The spring device according to claim 1, wherein said upper and lower plates have corresponding and aligned locking holes, respective, for riveting by pins.

3. The spring device according to claim 1, wherein said first elastic element comprises a plurality of series-connected helix torsion springs.

4. The spring device according to claim 1, wherein each of said blocking pieces is formed by stamping a C-shaped notch out of said upper plate and then bending a dangling piece surrounded by said C shape perpendicularly.
